(19) United States
(12) Patent Application Publication
(10) Pub. No.: US 2017/0022760 A1
(43) Pub. Date: Jan. 26, 2017

(54) Portable Ladder Solution System

(71) Applicant: Christopher Scott Egress, Rachel, WV (US)

(72) Inventor: Christopher Scott Egress, Rachel, WV (US)

(21) Appl. No.: 14/029,776

(22) Filed: Sep. 17, 2013

(51) Int. Cl. E06C 7/18

(52) U.S. Cl. CPC E06C 7/186

(57) ABSTRACT

The Portable Ladder Solution System is designed as a safety system used with portable extension ladders and any other ladders tall enough to require use of fall protection (J). The system uses any existing ladder (L), rope (D), rope guide (A, B, & C), anchor point (F), and rope grab (K) to safety act as a 100% safety tie off solution to anyone using the system. This system is vital to eliminating fatalities in the working industry.

### CROSSED-REFERENCED TO RELATED APPLICATIONS

None

### FEDERALLY SPONSORED RESEARCH

None

### SEQUENCE LISTING

None

### BACKGROUND

The section of occupational safety and health administrations and mining safety and health administrations rules/guidelines governing the ascending and descending of ladders is often times overlooked or disregarded in many industries such as mining and construction. I believe this could be changed if a solution were to be discovered to make this everyday task safer. Unnecessary risk can be eliminated by securing workers to a rope that goes up the center of the ladder.

While in a safety meeting our attention was drawn to an incident where a worker took a fatal fall from a ladder. The worker was climbing up the ladder to secure it when it slipped and he fell over 40 feet to his death. As my primary job as an electrician the tasks at hand requires frequent portable extension ladder use. This tragedy inspired me to create a solution to help prevent such incidents. I grabbed a rope and a ladder and started to experiment. First, I had to determine a way to secure the rope up the ladder while maintaining the ability to adjust the ladder. My first idea was to secure roller to the bottom of the top rung in which the rope would go up through then back to the base of the ladder. That design was going to put almost all the weight of the user onto the center of the top rung, which could break during a fall, sending the climber to the ground. Therefore, I thought to modify by evenly distributing the weight across the top rung of the ladder, mimicking human feet in which the ladder was designed to withstand. I drew up, traced out, modified and constructed a wooden prototype of this top rung bracket FIG. 4.

My first prototype of the top bracket was constructed out of three wooden 2×6's and had a hole drilled through the center of the boards in a curved direction so that the rope could guide through the wood and across the top rung easily. This wooden device was secured by screws through the side of the ladder to hold it securely on the top ladder rung. During testing I realized that while my original design worked well, it was not practical because it increased weight of the ladder, and therefore difficult to stand up. Extending the ladder was easy with the rope remaining through the top rope guide.

Based on the first prototype, the rope guide needed lightened. 1 decided aluminum best satisfy the weight and strength requirements to meet this goal. Also to create a long lasting guide for the rope, I thought up hardened plastic. After drawing up an aluminum bracket on paper I measured actual ladder rungs and traced the drawing onto cardboard. I used cardboard to make wooden templates. After having a wooden base I cut out a block out of sheets of plastic and cut a half moon shape out of the center plastic sheet for the center of the rope guide and screwed all the sheets together. I installed the plastic top guide block onto the wooden base template and had a built unit to test. I immediately installed it on the ladder and removed the 2×6 test piece. I very quickly noticed that it was much lighter than the other design as I set it up to test the newly built model. After performing the same test's I did on the first test 2×6's design I knew the new design was a success. Next I had to come up with a safe way to secure myself to the rope.

Starting with a device that “Petzl” manufacturer's called a Gri Gri a device designed for rope climbing. This device was capable of ascending the ladders rope safety easily by placing the device on the rope at the bottom of the ladder then the user could climb safety to the top of the ladder. The device would catch every time I would slip. After tying off the top of the ladder I then tested the device by jumping off, slipping down, sitting down, reaching out, and slipping off the side of the ladder and the device caught me every time. Then to work off of the unit I could rely on the rope to hold me and I could safely reach out resting on the rope to hold me and I could work comfortably. However, when I wanted to go down I had to remove that device and climb down unsafely. To eliminate this unsafe act I found a device that would go up and down. The Fuji Denko was the device that said it could do just that, up and down the rope without removing it from the rope. Finding a device that worked well with my set up was a relief and using it or any device like it would be the way to go.

### SUMMARY

The use of the portable ladder safety guide (A, B&C), rope anchor point (F), ⅝″ rope (D), full body harness (J) and a rope grab (K) would enable an individual to safely climb a portable ladder without ever having to remove their fall protection. This solution system is a tremendous and necessary advantage in an industry where portable ladders are part of everyday jobs.

### Objective of the Invention

The Portable Ladder Solution System is a system designed to be used as a 100% tied off solution for portable ladders. This system is the solution to eliminate falls from ladders from everything between the ascents to tie the ladder off through the descent to the ground. This system will be capable of being fitted to all extension ladders and step ladders that are tall enough to utilize a safety. The system will work with a device that is capable of ascending and descending a portable ladder on a guide rope, without ever having to undo or redo the user's fall protection device. In addition, this solution system is also capable of being used as a working safety once the ladder is secured with side to side fall risks eliminated by tying the ladder off with whatever means necessary to prevent it from falling. This system is designed to fit portable ladders and does not affect the integrity of the ladder.

The Portable Ladder Solution System will consist of one or more devices that attach to the ladder, and will be capable of removal and replacement as necessary. The system will utilize a full body harness with waist and chest attachment capabilities. There will be a rope guide at the top of the ladder (FIGS. 1 & 2) and an anchor point at the bottom of the ladder (FIG. 6). ⅝″ static rope (D) or ⅝″ dynamic rope (D) then runs from the bottom anchor point (F) through the top rope guide (C) and reconnected to the bottom anchor point (F) by means of a rope ascender/anchor (E) that is fixed to the rope anchor point (FIG. 3). The use of a rope grab (K) device like the Fuji Denko or similar device will be used with the system attached to a full body harness on all users.

Advantages of the Rope Ladder Solution:

1. Will save lives.

2. Easy to use.

3. Compatible with ladders that are already being used every day.

4. Lightweight to eliminate burden on users.

5. User Friendly to maintain efficiency.

6. Will not impact integrity of ladders or compromise efficiency of ladder use.

### REFERENCES

1. U.S. Pat. No. 5,323,873; Incorporates the rope grab device similar to what would be used in the portable ladder solution system. This patent is not used as a ladder climbing solution, but mainly as a secondary safety device while using rope ascending gear to climb another rope. Also, this device was said to be used as rooftop safety line where it could slide back and forth allowing the user of this device to move around the edge of a roof freely and safely secured to a lifeline. I am not trying to patent this device but merely use a similar device covered here with my invention to achieve the fall protection requirements.
2. U.S. Pat. No. 8,353,387 Vollenweider patent date Jan. 15, 2013: Uses a metal track like device to slow the descent rate in the event of a fall. The invention does not mention the use on a portable ladder but does mention usage on a ladder and scaffoldings. However, I am not planning on using a similar track like system due to the fact that this system is heavy and not feasible for a light weight portable ladder that is continuously being lifted and adjusted.
3. U.S. Pat. No. 7,014,594 Stoltz, Mar. 21, 2006: In this invention the claims are for use of rope and a one direction ascender unlike my proposed ascending and descending device called a rope grab. Stoltz's invention was designed for a trapeze set-up with use of a singled ascending rope that was secured to a trapeze tower. This patent does not mention a portable ladder or descending the same device or ladder.
4. U.S. Pat. No. 8,251,179 Anderson, et al. Aug. 28, 2012. This invention is called a portable safety ladder assembly but is not a close resemblance to the invention I am proposing due to the absence of ropes or safety harnesses. Anderson's portable safety ladder assembly is used on a railing on a portable ladder which allows the user better grips on a ladder especially in times of transferring to scaffolding or other platform.

Similar climbing techniques out there exist for fixed/permanently mounted ladders. One technique involves the steel cable being secured at both the top and bottom of the permanently fixed ladder. Once cable is secured the user can hook to the cable with a metal cable specific grab device and ascend and descend the ladder. In the event of a fall the device will catch the user. This is the same concept I am suggesting with several modifications and manufactured parts to effectively use it on a portable ladder.

Another technique is a rope grab setup that is used to ascend ropes without the use of a portable ladder. In this set up, the user is hanging from the rope and using rope ascender's to go up the rope and rappelling devices to go down the rope. Rope ascending can be very technical and requires very advanced climbing techniques that would not be favorable or cost effective to the industry. I am not suggesting the same practice be used in my portable ladder solution system.

### DESCRIPTIONS OF THE DRAWINGS

FIG. 1 is a drawing which includes a view of the top portion of the portable extension ladder with the rope safety guide (A, B, &C) shown on the ladders top rung (M) giving the front view.

FIG. 2 is an exploded isometric view of the rope safety guide (A, B, &C) block drawn in detail.

FIG. 3 is the proposed system, drawn with both the top portion of the ladder and the bottom portion of the system (F, G, I, &E) on the ladder rungs with the rope (D) shown as well.

FIG. 4 is a close up side view of the ladder rung clamp (A&B).

FIG. 5 is a close up side view of the rope guide block (C) showing the rope guide channel.

FIG. 6 is an isometric view of the rope anchor point (F).

FIG. 7 is a drawing of a portable ladder rung protector (H).

FIG. 8 is an assembled isometric drawing of the rope safety guide (A, B, &C)

### DETAILED DESCRIPTION OF THE PREFERRED EMBODIMENTS

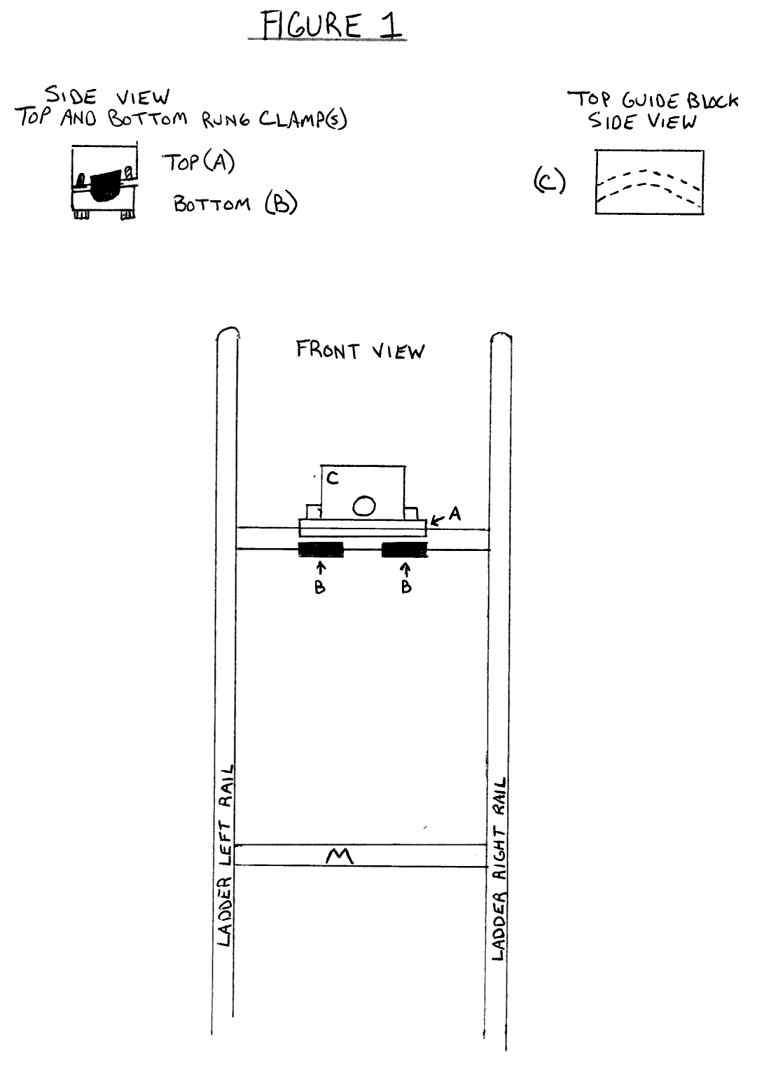

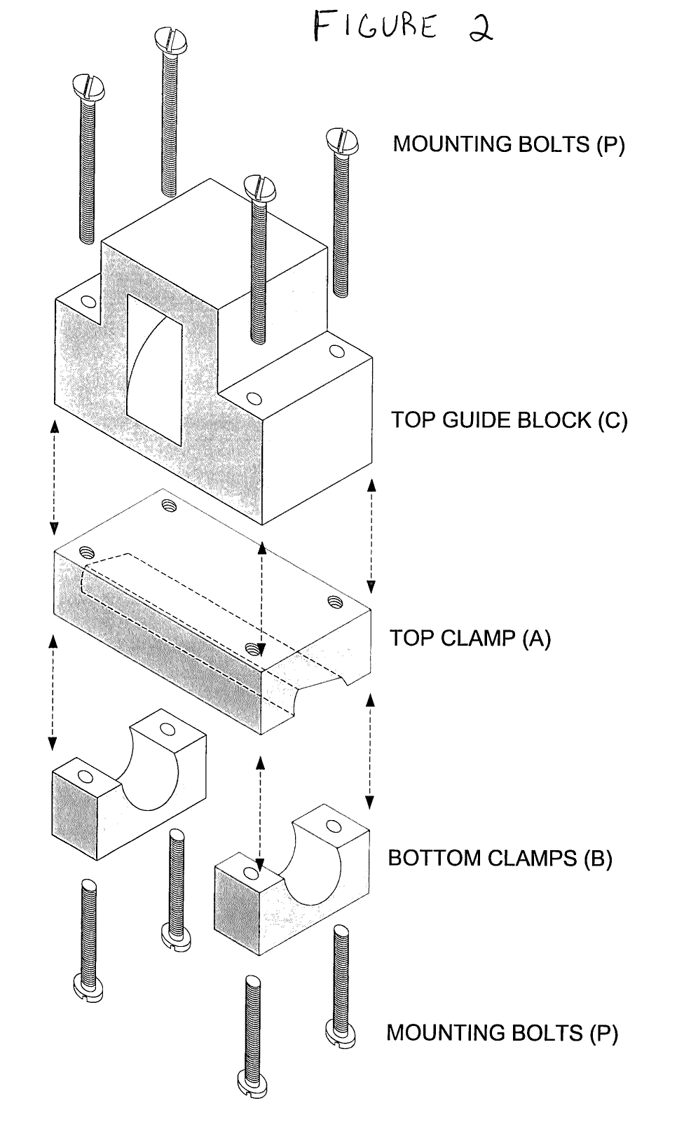

The main embodiment in FIG. 1 is the portable ladder rope safety guide (A, B, &C) shown on the top rung of the ladder (L). In this illustration the ladder rope safety guide block is drawn as I have tested it to the length of 8 inches. This length has worked well in the testing process and proves to be substantial in strength. In the center of the top guide block (C) there is a hole to show the rope tunnel where the rope goes through the top guide block (C). More details on the tunnel in the top guide block (C) are shown in FIG. 2. Also included in the figure in the top left hand corner is a brief side view for a quick and easy reference to what is being shown in the middle of the page, but as a side view and disassembled from the top guide block (C). This view includes the top clamp (A) and the bottom clamp (B) in which the shaded spot between the top (A) and bottom clamp (B) represents the ladder rung (L) side view.

In the top right hand corner is a brief side view of the top guide block (C) shown as a quick reference. The dotted lines shown on this device demonstrate that there is a drilled tunnel in an arch form in the center of the block. This tunnel is where the rope will run through and is basically a hole bored through the proposed hardened plastic top guide block (C).

FIG. 2 is an exploded isometric drawing of the proposed rope safety guide block (A, B, &C). The rope safety guide block that I am proposing is constructed of both aluminum and plastic, but is not limited to those materials. The device could possibly be made lighter and smoother with other materials, but in order to remain cost efficient I am implementing aluminum top (A) and bottom clamps (B). The aluminum clamps (A&B) are strong enough to handle a person's weight and are constructed from the same material as the ladder rungs (M), which will help prevent rust or corrosion after long term use on aluminum ladder rungs. In the bottom clamps there are circles where I'm implementing drilled holes (O) approximately ¼″ in diameter for the use of a bolt through the bottom clamps (B). In both the right side and the left side of the bottom clamps there could be a total of 2 to 4 holes (O) in each clamp up to two holes (O) on the front side of each bottom clamps and up to two drilled holes (O) on the back side of each bottom clamps (B). There are a total of two bottom clamps (B), a right side and a left side. The bottom clamps (B) are fitted to the ladder rung (M) to prevent it from rolling, which can better be seen in the side view in the top left corner of FIG. 1.

Both the top clamp (A) and the bottom clamp (B) I am implementing in the drawing are made of aluminum. There is one solid piece of aluminum for the top clamp (A) which could be 8 inches in length as is the length I tested. The top clamp (A) is form fitted to the ladder rung (M) to prevent it from rolling and can better be seen in the side view of FIG. 1. Inside to the top clamp (A) there will be threaded holes (N) which are drawn by holes (N) with parallel lines drawn inside them. I am implementing up to four threaded holes (N) in the left and an additional four holes in the right side of the top clamp (A) accessible from the bottom. The intent of the bottom accessible threaded holes (N) is to be able to secure the bottom clamp (B) to the top clamp (A) with the use of bolts (P). A series of bolts (P) would come up through the drilled holes (N) in the bottom clamps (B) and into the threaded holes in the top clamps (A). Once the top clamp (A) is bolted to the bottom clamp (B) around the top ladder rung (M) the clamps will then be secured to the ladder rung (M). The threaded holes (N) that are accessible from the top of the top clamp (A) are for the use of securing the top guide block (C) onto the top clamp (A). Once the top clamp (A) is bolted to the bottom clamps (B) around the top ladder rung (M) and the top guide Block (C) is bolted to the top clamp (A), the portable ladder safety guide (A, B, &C) is assembled on the ladder rung (M) and ready to be fitted with a rope (D).

The top guide block (C) needs to be smooth, so I am implementing a hardened plastic to do this task. The job of the top guide block is to provide a smooth surface for the rope to travel over while clearing the aluminum ladder rung (M) that the portable ladder safety guide is secured to. The strength of the top guide blocks (C) needs to be substantial enough to hold a person's weight from crushing the block upon a fall. To successfully achieve this I am implementing the top guide block (C) be made of solid hardened plastic. The top guide block (C) is a solid piece of hardened plastic with flanges designed into the mold on both the left and the right side to allow the top rope guide to be bolted easier with shorter bolts to the top clamp (A). In the flanges there could be anywhere from two to four bolts (P) in each flange to secure it to the top clamp (A). There is a half-moon hole drilled through the top rope guide block (C) that enters through the front and out the back of the of the top rope guide (C). The hole drilled through can be anywhere from ⅝ inches in diameter to 2 inches in diameter. The half-moon design's sole purpose is to make it easier for the rope (D) to slide through the top rope guide (C) while the user adjusts the ladder height from the ground. The width of the top rope guide (C) is designed to clear the aluminum rungs (M) while allowing the easiest and safest way to adjust the rope (D) tension from the ground.

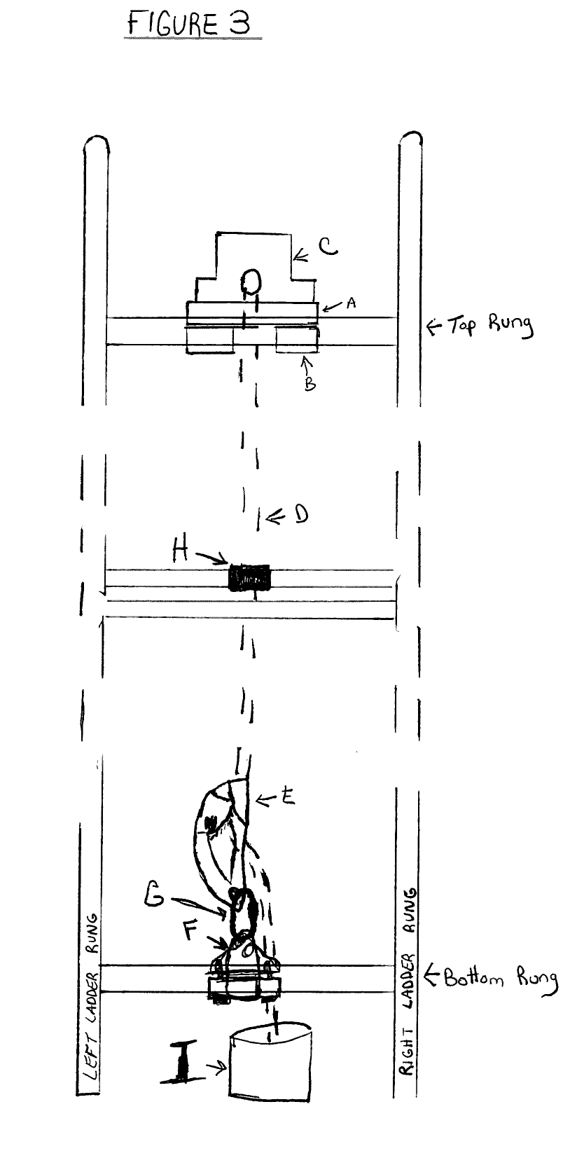

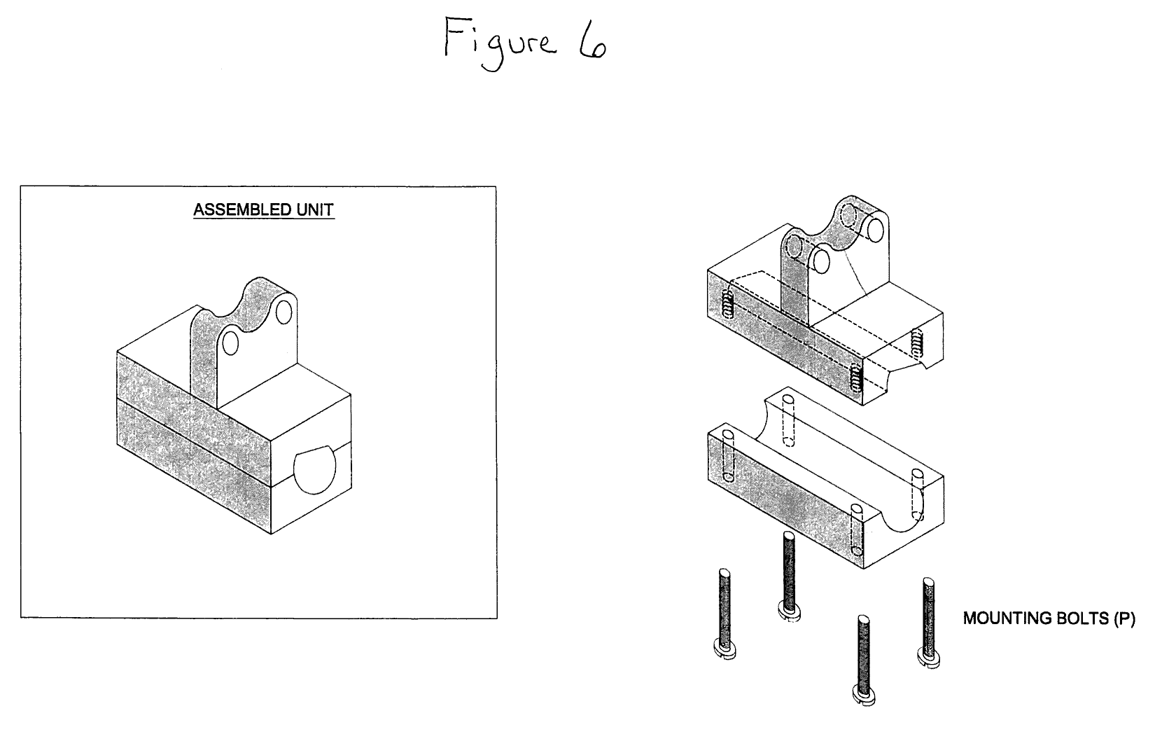

FIG. 3 is the process in which the unit will be used as is whole on the ladder (L). Figure three has all the components of the portable ladder solution system without the user or the rope grab/Fuji Denko (K). The ladder is shown with the portable ladder safety guide (A, B, C) positioned on the top ladder rung (M). Illustrated with paralleled dotted lines is the ⅝ inch rope (D) that runs down from the portable ladder safety guide (A, B, C) past the portable ladder rung protector (H) through the anchor/ascender (E) past the mallion (G) and finally past the rope anchor point (F) into the proposed rope bag (I). This is the process that it takes to set up the portable ladder solution system without the rope grab/Fuji Denko (K). The ropes (D) short end is routed through the front of the portable ladder safety guide and comes out the back and down the ladder past the portable ladder rung protector (H) and anchors on the rope anchor points (F) back anchoring eye. For more detail on the anchoring eye, see FIG. 6. Once the rope (D) is routed and anchored it needs to be tensioned from the front of the ladder by pulling down on the rope (D) tight and securing it into the anchor/ascender (E). Once the rope (D) is tight the rope (D) is then ready to be used as a safety to ascend up using a rope grab or Fuji Denko (K) and tie the ladder off securely. The rope bag (I) is only a suggested idea to keep the rope cleaner than if it were laid in the dirt during every use. The mallion (G) is a connecting device that can be used to connect an anchor/ascender to the rope anchor point (F). The mallion is only the suggested connecting device but any climbing rated connecting device will do the same job.

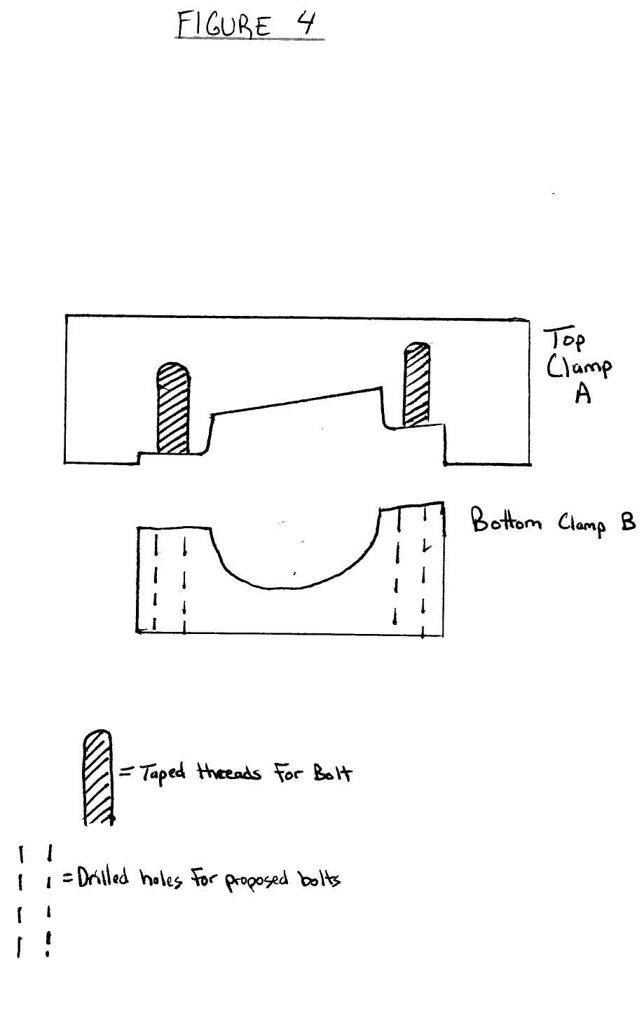

FIG. 4 is a detailed side view drawing of the top (A) and bottom clamps (B) discussed in FIG. 2 in great detail. The top (A) and bottom clamps (B) are shown not to scale but to a much more accurate drawing of the actual tested and proposed prototype.

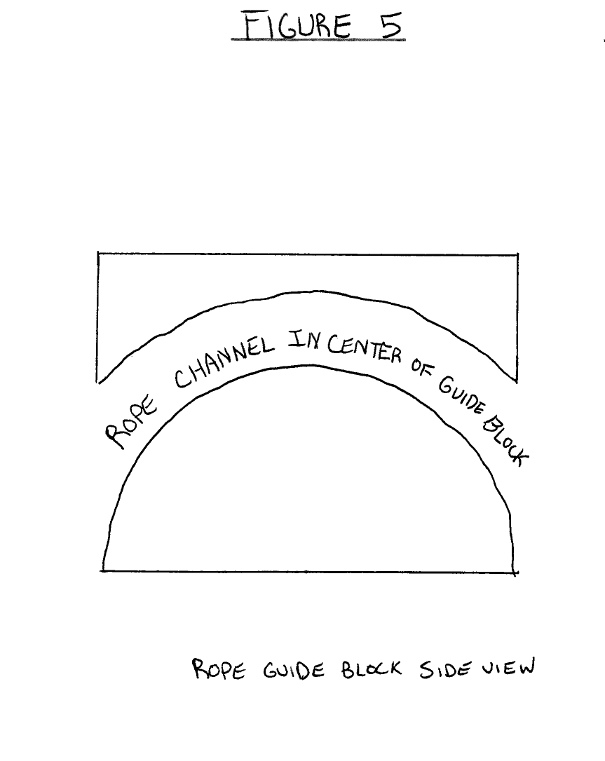

FIG. 5 is a detailed side view drawing of the top guide block (C) that is discussed in great detail in FIG. 2. In FIG. 5 a more detailed description is shown of the discussed half-moon design for the rope to glide easier. The hole drilled through can be anywhere from ⅝ inches in diameter to 2 inches in diameter. The half-moon design's sole purpose is to make it easier for the rope (D) to slide through the top rope guide (C) while the user adjusts the ladder height from the ground then tensioning the rope (D) using the anchor/ascender (E). The material is proposed to be solid hardened plastic to maximize strength.

FIG. 6 is a detailed drawing of the rope anchor point (F). The right drawing is and exploded view and the left drawing is an assembled view. The rope anchor point is fitted to the ladder rung (M) to prevent it from rolling as seen in the top (A) and bottom (B) clamp. There are two parts comprising the rope anchor point (F). Part one (P1) is the top which has the anchoring eye's (Q) and threaded holes (N). Part two (P2) is the bottom which has drilled holes (O), to allow a series of bolts (P) to pass through, clamping the bottom to the top and forming the rope anchor point (F). Both the top and bottom portion will be made from aluminum and anywhere from 3 inches to 5 inches in length, measured horizontal with the rung (M) for each piece, part one and part two. Part one (P1) is the actual rope anchoring point (F) in which the rope (0) ends (short and long) will be secured to. Part one (P1) is to have two anchoring eyes (Q) fabricated into the aluminum body. There will be a anchoring eye (Q) in the front of Part 1 (P1) and another anchoring eye (Q) in the back of part one (P1). Part 2 (P2) of the rope anchor point (F) is the bottom of the clamp in which the bolts will run through the piece and secure it to the top piece know as part one (P1). Part 2 (P2) is the same length and width as part 1 (P1) with the bottom of part 2 (P2) being flat as its sole purpose is to hold part 1 (P1) to the ladder rung and distribute the weight evenly across the ladder rung (M) when weight is applied.

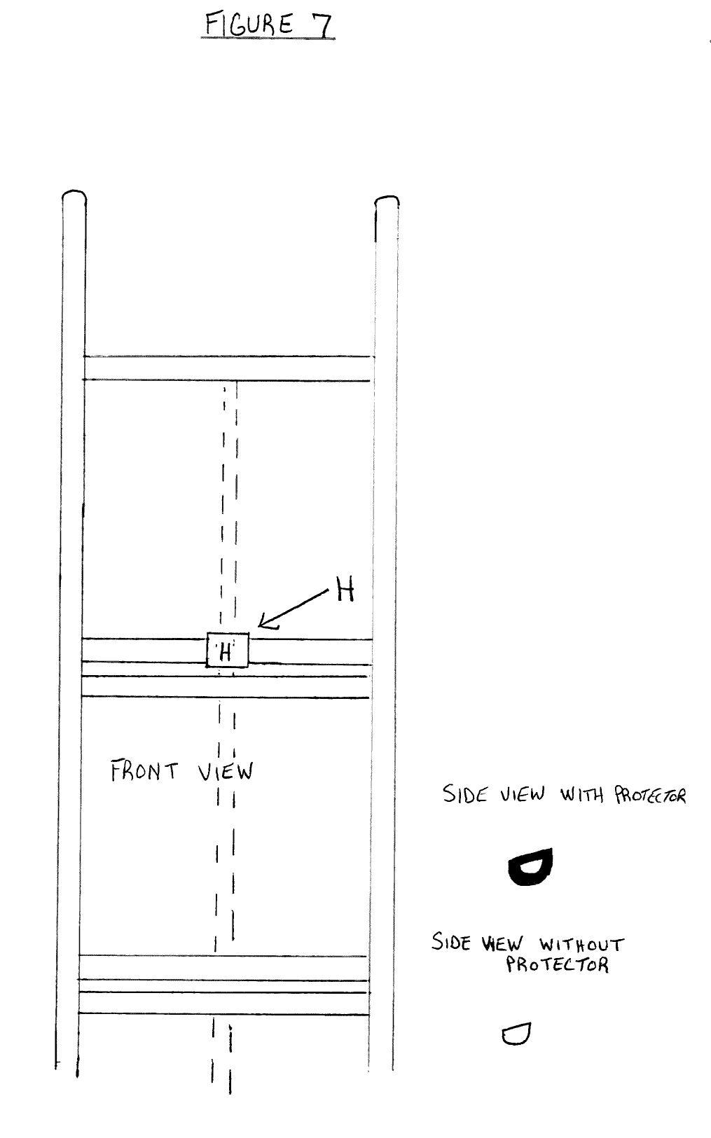

FIG. 7 is a simple drawing of a piece of material, most likely plastic, being secured to the middle of the ladder (L). This piece of plastic is known as the portable ladder rung protector (H). This portable ladder rung protector (H) will be placed on the top rung of the bottom section of a portable extension ladder. This device is necessary to prevent the rope (D) on the back where the two portions of the ladder meet from rubbing the top rung (M) of the lower portion. In order to keep the rope from wearing the aluminum top rung (M) the portable ladder rung protector (H) will be installed. To protect the ladder rung effectively, the portable ladder rung protector (H) will be placed in the center of the rung and be approximately 2 to 3 inches in length, measured from left to right across the ladder rung (M). The protector (H) could have ridges on the outside edges to prevent the rope from siding off onto the rungs. Two drawings on the right of FIG. 7 the top of the two drawing labeled side view with protector, show the protector (H) installed. Below that drawing is the side view without protector (H) to show the difference without the portable ladder rung protector (H) on the ladder rung (M).

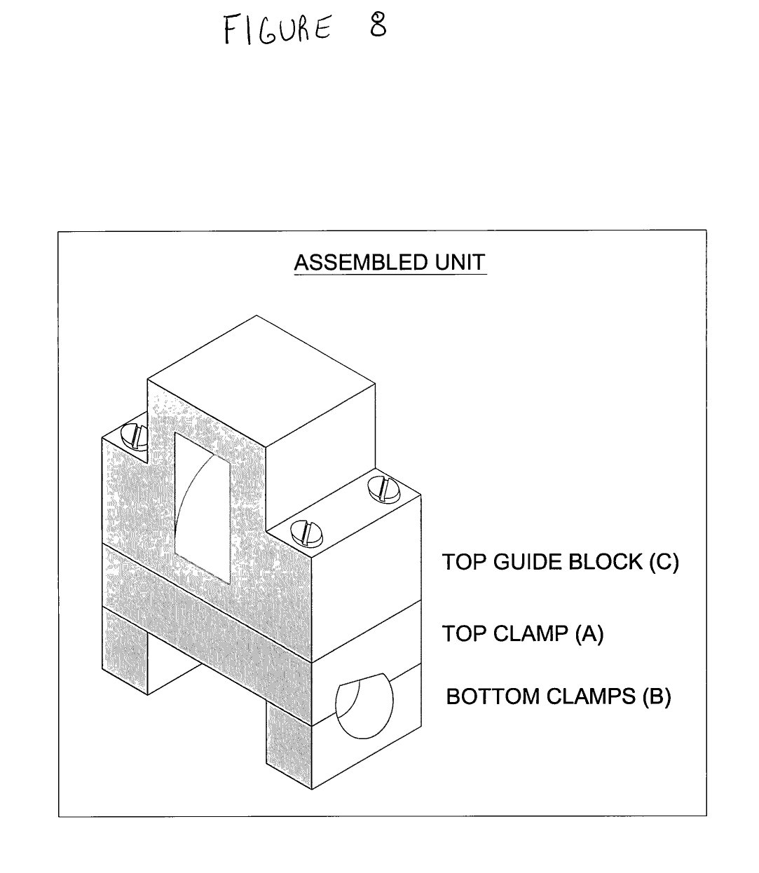

FIG. 8 is an assembled unit of the ladder rope safety guide block in an isometric view. The ladder rope safety guide block has all three units shown assembled. Units assembled are the top guide block (C), top clamp (A), and bottom clamp (B). The combination of those three units secured together make up the ladder rope safety guide block which is designed to bolt to a ladder rung (M).

### REFERENCE NUMERALS

Portable ladder safety guide (A, B, & C)
Top Rung Clamp (A)
Bottom Rung Clamp (B)
Top guide block (C)
Ladder rung clamp (A &B)
Rope ⅝″ in diameter (D)
Anchor/Ascender (E)
Rope anchor point (F)
Rope Anchor Point Part One (P1)
Rope Anchor Point Part Two (P2)
Mallion (G)
Portable ladder rung protector (H)
Rope bag (I)
Full Body Harness (J)
Rope Grab/Fuji Denko (K)
Ladder (L)
Ladder Rung (M)
Threaded holes (N)
Drilled Holes (O)
Bolt (P)
Anchoring Eyes (Q)

I claim:

1. A device or group of devices secured onto a portable ladder with the intent of a rope guide for the use of fall protection.

2. A device secured onto a portable ladder with the intent of a rope anchor point for the use of fall protection.

3. A rope secured on a portable ladder for the intent as a horizontal safety.

4. Wherein claim 1 such device be made so that said rope could guide through it clearing the ladder rungs from the rope.

5. Wherein claim 1 the device be made smooth and of light weight material of substantial strength.

6. Wherein claim 1 the rope will be guided through the device and both ends secured back to the bottom of the portable ladder on said claim 2 device.

7. Wherein claim 1 the device be made of material structurally strong enough to meet the requirements of approved fall protection.

8. Wherein claim 2 the device be made of lightweight material.

9. Wherein claim 2 the device be able to anchor both the short end and the adjustable device anchor/ascender.

10. Wherein claim 2 the device be made of material structurally strong enough to meet the requirements of approved fall protection.

11. Wherein claim 3 rope that is positioned on a portable ladder doubled up and back down or secured means only from top to bottom.
